(19) United States
(12) Patent Application Publication
(10) Pub. No.: US 2015/0222179 A1
(43) Pub. Date: Aug. 6, 2015

(54) ELECTRIC POWER DEVICE AND METHOD FOR PROVIDING ELECTRIC POWER IN ELECTRIC POWER DEVICE

(71) Applicant: Samsung Electronics Co., Ltd., Suwon-si (KR)

(72) Inventors: Chul-Eun YUN, Hwaseong-si (KR); Kisun LEE, Hwaseong-si (KR)

(21) Appl. No.: 14/606,547

(22) Filed: Jan. 27, 2015

(30) Foreign Application Priority Data
Feb. 3, 2014 (KR) 10-2014-0012130

(51) Int. Cl. H02M 3/04

(52) U.S. Cl. CPC H02M 3/04

(57) ABSTRACT

An electric power device and a method for providing an electric power in the electric power device capable of improving efficiency of a conductor while decreasing an area where the electric power device is mounted are provided. The electric power device includes an inductor, and a plurality of converters configured to output voltages using the inductor.

### CROSS-REFERENCE TO RELATED APPLICATION(S)

This application claims the benefit under 35 U.S.C. §119(a) of a Korean patent application filed on Feb. 3, 2014 in the Korean Intellectual Property Office and assigned Serial number 10-2014-0012130, the entire disclosure of which is hereby incorporated by reference.

### TECHNICAL FIELD

The present disclosure relates to an electric power device and a method for providing an electric power in the electric power device. More particularly, the present disclosure relates to an electric power device and a method for providing an electric power in the electric power device capable of improving efficiency of a conductor while decreasing an area where the electric power device is mounted.

### BACKGROUND

A Power Management Integrated Circuit (PMIC) is widely used in all sorts of electronic goods to be operated with a battery, as an Integrated Circuit (IC) providing power.

In addition, a plurality of DCDC converters may be included in the PMIC, so as to output a regular voltage to be applied to a load.

The DCDC converters included in the Power Management Integrated Circuit (PMIC) which need inductors. For example, when the load requires that +4V is applied to a positive (+) terminal and −4V is applied to a negative (−) terminal, a DCDC converter outputting +4V and a DCDC converter outputting −4V are needed, and thus the DCDC converters respectively need the inductors.

A change rate of a current should be little so as to increase efficiency of a power conversion. In addition, an inductance should be great so as to decrease the change rate of the current. A winding of a conducting wire should be great so as to increase the inductance.

However, when the number of the windings of the conducting wire increases, a volume of the inductor increases and loss may occur due to an increased resistance.

Therefore, a need exists for an electric power device and a method for providing an electric power in the electric power device capable of improving efficiency of a conductor while decreasing an area where the electric power device is mounted.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electric power device including an inductor, and a plurality of converters configured to output voltages using the inductor.

In accordance with another aspect of the present disclosure, an electric power device is provided. The electric power device includes an inductor, a first converter configured to output a first voltage using the inductor, and a second converter configured to output a second voltage using the inductor.

The electric power device and the method for providing the electric power in the electric power device according to various embodiments of the present disclosure may decrease a Printed Circuit Board (PCB) mounting area and generate a greater inductance in an inductor with the same winding of a conducting wire.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a configuration diagram illustrating an electric power device according to an embodiment of the present disclosure;

FIG. 2A is a diagram illustrating a single edge modulation method used in an electric power device according to the related art;

FIG. 2B is a diagram illustrating a dual edge modulation method used in the electric power device according to an embodiment of the present disclosure;

FIG. 3 is a flowchart illustrating a voltage output operation of a first DCDC converter in an electric power device according to an embodiment of the present disclosure; and

FIG. 4 is a flowchart illustrating a voltage output operation of a second DCDC converter in an electric power device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

An electronic device in which an electric power device according to various embodiments of the present disclosure is used may be a device including a communication function. For example, the electronic device may be one or more combinations among various devices, such as a smartphone, a tablet personal computer, a mobile phone, a video telephone, an e-book reader, a desktop personal computer, a laptop personal computer, a netbook computer, a personal digital assistant, a portable multimedia player, a Motion Pictures Expert Group (MPEG-1 or MPEG-2) Audio Layer 3 (MP3) player, a mobile medical device, an electronic bracelet, an electronic necklace, an electronic accessory, a camera, a wearable device, an electronic clock, a wrist watch, a home appliance (for example, a refrigerator, an air conditioner, a cleaner, an oven, a microwave oven, a washing machine, an air cleaner, and the like), an artificial intelligence robot, a TV, a Digital Video Disk (DVD) player, an audio, various medical devices (for example, a Magnetic Resonance Angiography (MRA), a Magnetic Resonance Imaging (MRI), a Computed Tomography (CT), a movie camera, an ultrasonic device, and the like), a navigation device, a Global Positioning System (GPS) receiver, an Event Data Recorder (EDR), a Flight Data Recorder (FDR), a set-top box, a TV box (for example, Samsung HomeSync™, Apple TV™, or Google TV™), an electronic dictionary, a car infotainment, an electronic equipment for ship (for example, a navigation equipment, a gyrocompass for ship, and the like), an avionics, a security device, an electronic dress, an electronic key, a camcorder, a game console, a Head-Mounted Display (HMD), a flat panel display device, an electronic frame, an electronic album, a furniture or a portion of building/construction having a communication function, an electronic board, an electronic signature receiving device, a wearable device, a projector, and the like. It is obvious to a person having ordinary skill in the art that the electronic device according to the various embodiments of the present disclosure is not limited to the above-mentioned devices.

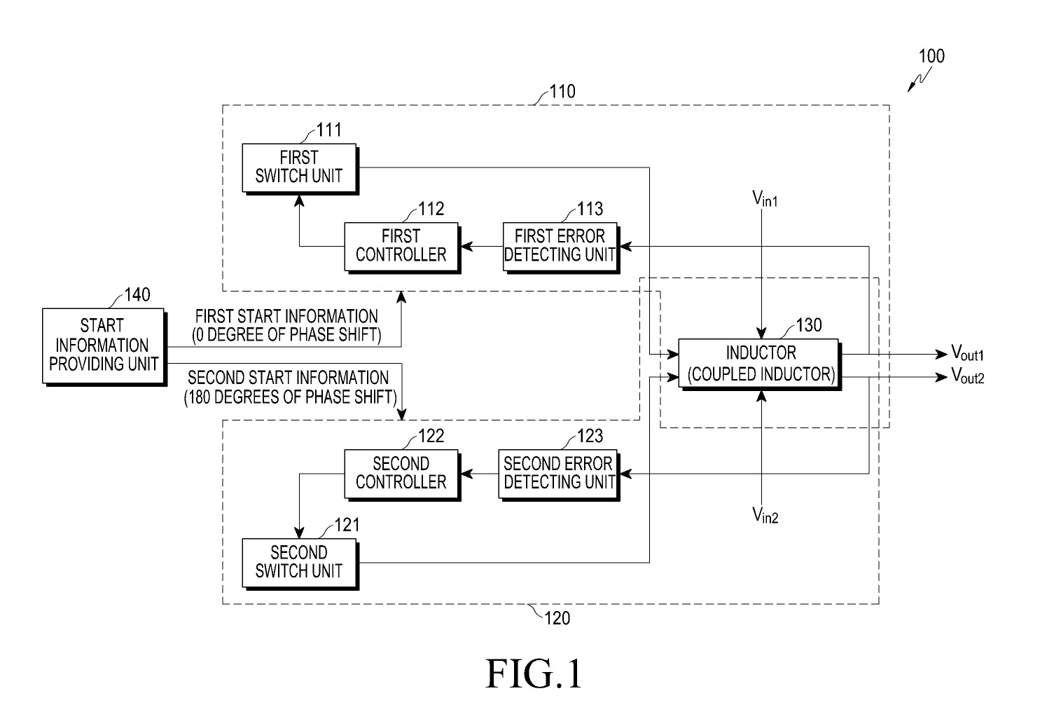

In the electric power device of FIGS. 1, 2A, 2B, 3, and 4, it is described that two DCDC converters connected to a power rail use an inductor as an example, but when two or more DCDC converters connected to the power rail use the inductor, it may be equally applied to the present disclosure.

FIG. 1 is a configuration diagram illustrating an electric power device according to an embodiment of the present disclosure.

Referring to FIG. 1, the electric power device 100 includes a first DCDC converter 110 and a second DCDC converter 120 connected to a power rail, and the first DCDC converter 110 and the second DCDC converter 120 may use an inductor 130. The inductor 130 may include a coupled inductor.

In addition, the electric power device 100 may include a start information providing unit 140. The start information providing unit 140 may transmit first start information including phase shift information different from phase shift information included in second start information to a first controller 112, so as to prevent a simultaneous on or off state of a first switch unit 111 and a second switch unit 121. In addition, the start information providing unit 140 may transmit the second start information including the phase shift information different from the phase shift information included in the first start information to a second controller 122.

In the present embodiment of the present disclosure, the phase shift information included in the first start information may be about 0 degree, and the phase shift information included in the second start information may be about 180 degrees.

The first converter 110 may include the first switch unit 111, the first controller 112, a first error detecting unit 113 and the inductor 130.

The first switch unit 111 may be turned on or turned off according to a control signal transmitted from the first controller 112.

When the first controller 112 receives the first start information including the phase shift information (0 degree) from the start information providing unit 140, the first controller 112 may transmit the control signal for performing a switch on or a switch off to the first switch unit 111 without delay according to the phase shift information (0 degree).

During a period when a switch unit is turned on and turned off, an output voltage of a DCDC converter may be controlled according to a maintenance time of an on state (duty state) of the switch unit. In other words, more current is stored in the inductor when the on state (duty state) is long. Therefore, when the switch unit is in an off state, an input voltage and a voltage of the inductor are added, and thus an increased voltage may be outputted.

Therefore, the first controller 112 may transmit the control signal capable of maintaining the on state (duty state) of a switch of the first switch unit 111 for a certain time by a period when the first switch unit 111 is turned on and turned off, so that the first DCDC converter 110 outputs a voltage.

In addition, when the first controller 112 receives error occurrence information of a first voltage Vout1 output from the inductor 130 from the first error detecting unit 113, the first controller 112 may remove an error of the voltage output from the inductor 130 using a dual edge modulation method.

Error of an input voltage Vin1 provided from a battery may occur according to internal and external factors, such as amount used, time elapsed, a change of an output current, a change of a temperature, and the like. Therefore, the first voltage Vout1 greater or less than a voltage may be outputted from the inductor 130.

When the first controller 112 detects the output of the first voltage Vout1 different from the voltage from the inductor 130 using the first error detecting unit 113, the first controller 112 may transmit the control signal capable of increasing or decreasing the maintenance time of the switch on state (duty state) of the first switch unit 111 to the first switch unit 111 in order to control the first DCDC converter 110 so that the first DCDC converter 110 outputs the voltage.

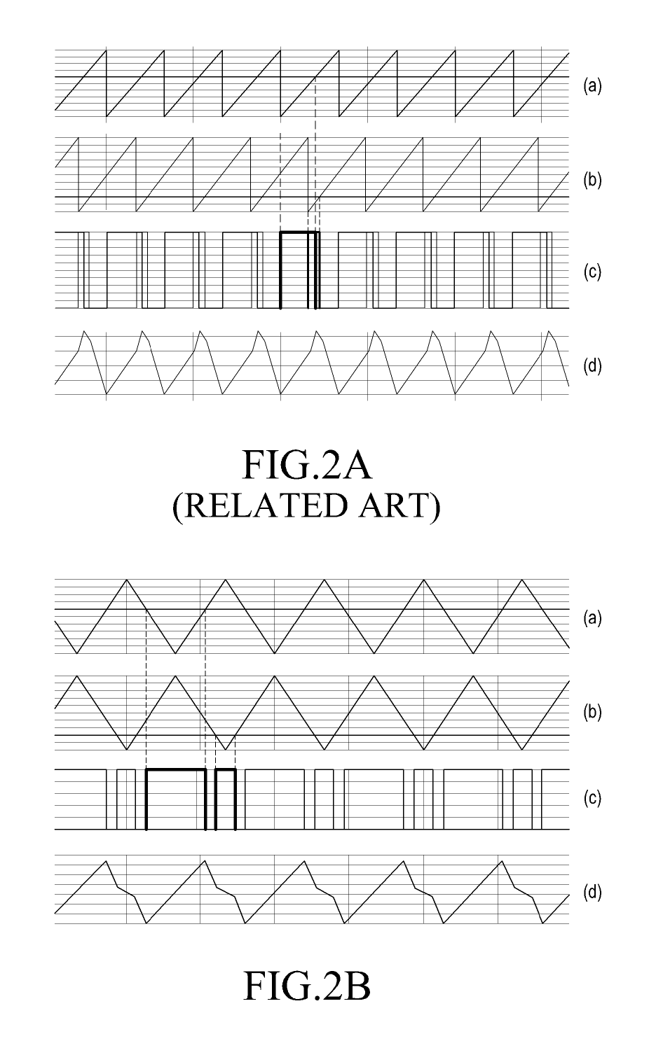

The dual edge modulation method used for removing the error (i.e., a voltage increase or decrease) of the first voltage Vout1 output from the inductor 130 is a method changing both of a time point when an on state starts and a time point when an on state ends in a method of controlling the on time of the switch to be controlled. Therefore, the first switch unit 111 and the second switch unit 112 may be prevented from being simultaneous on states as well as the error of the first voltage Vout1 output from the inductor 130 may be removed. The dual edge modulation method will be described with reference to FIG. 2B.

The first error detecting unit 113 may detect the first voltage Vout1 outputted from the first DCDC converter 110, compare the first voltage Vout1 with a first critical voltage, and transmit the error occurrence information to the first controller 112, when the first voltage Vout1 and the first critical voltage are different from each other according to the comparison result. The first critical voltage may correspond to the voltage of the first DCDC converter 110.

The second converter 120 may include the second switch unit 121, the second controller 122, a second error detecting unit 123 and the inductor 130.

The second switch unit 121 may be turned on or turned off according to a control signal transmitted from the second controller 122.

When the second controller 122 receives the second start information including the phase shift information (180 degrees) from the start information providing unit 140, the second controller 132 may transmit the control signal for switching the second switch unit 121 on or off to the second switch unit 121 after 180 degrees of phase delay according to the phase shift information (180 degrees).

The second controller 122 may transmit the control signal capable of maintaining the on state (duty state) of the second switch unit 121 for a time by a period when the second switch unit 121 is turned on and turned off, so that the second DCDC converter 120 outputs a voltage.

In addition, when the second controller 122 receives error occurrence information of a second voltage Vout2 outputted from the inductor 130 from the second error detecting unit 123, the second controller 122 may remove an error of the voltage outputted from the second DCDC converter 120 using the dual edge modulation method.

An error of an input voltage Vin2 provided from the battery may occur according to internal and external factors, such as amount used, time elapsed, a change of an output current, a change of a temperature, and the like, therefore the second voltage Vout2 greater or less than the voltage may be outputted from the second DCDC converter 120.

When the second controller 122 detects the output of the second voltage Vout2 different from the voltage of the second DCDC converter 120 using the second error detecting unit 123, the second controller 122 may transmit the control signal capable of increasing or decreasing the maintenance time of the switch on state (duty state) of the second switch unit 121 to the second switch unit 121 in order to control the second DCDC converter 120 so that the second DCDC converter 120 outputs the voltage.

The dual edge modulation method used for removing the error (voltage increase or decrease) of the second voltage Vout2 outputted from the inductor 130 is the method changing both of the time point when the on starts and the time point when the on ends in the method of controlling the on time of the switch to be controlled. Therefore, the first switch unit 111 and the second switch unit 112 may be prevented from being simultaneous on or off states as well as the error of the second voltage Vout2 output from the inductor 130 may be removed. The dual edge modulation method will be described with reference to FIG. 2B.

The second error detecting unit 123 may detect the second voltage Vout2 output from the single inductor 130, compare the second voltage Vout2 with a second critical voltage, and transmit the error occurrence information to the second controller 122, when the second voltage Vout2 and the second critical voltage are different from each other according to the comparison result. The second critical voltage may correspond to the voltage of the second DCDC converter 120.

FIG. 2A is a diagram illustrating a single edge modulation method used in an electric power device according to the related art.

Referring to FIG. 2A, (a) illustrates a signal generated from the first controller, as a voltage for controlling the on or off of the first switch unit in the first DCDC converter, and (b) in FIG. 2A illustrates a signal generated from the second controller, as a voltage for controlling the on or off of the second switch unit.

In FIG. 2A, (c) illustrates the period that the first switch is in the on or off state in the first DCDC converter and the period that the second switch unit is in the on or off state in the second DCDC converter. In FIG. 2A, (d) illustrates a current of the inductor.

The single edge modulation method moves up or delays the time point when the switch is turned off while fixing the time point when the switch is to be turned on, when the time of the on state (duty state) of the switch unit is changed (i.e., increased or decreased) so as to remove the error (i.e., a voltage increase or decrease) of the output voltage. For example, since the duty state is increased or decreased at a single edge, the first switch unit 111 and the second switch unit 121 may be turned on simultaneously.

FIG. 2B is a diagram illustrating the dual edge modulation method used in the electric power device according to an embodiment of the present disclosure.

In FIG. 2B, (a) illustrates a signal generated from the first controller 112, as a voltage for controlling the on or off of the first switch unit 111 in the first DCDC converter 110. In FIG. 2B, (a) illustrates a triangular waveform receiving the first start information, and an output signal (error signal) of the first error detecting unit 113 overlapping with each other.

In FIG. 2B, (b) illustrates a signal generated from the second controller 122, as a voltage for controlling the on or off of the second switch unit 121 in the second DCDC converter 120. In FIG. 2B, (b) illustrates a triangular waveform receiving the second start information, and an output signal (error signal) of the second error detecting unit 123 overlapping with each other.

In FIG. 2B, (c) illustrates the on or off period of the first switch unit 111 in the first DCDC converter 110, and the on or off period of the second switch unit 121 in the second DCDC converter 120. In FIG. 2B, (c) illustrates an output signal of the first controller 112 and an output signal of the second controller 122 overlapping with each other. The output signal of a controller is a voltage when the error signal is greater than the triangular waveform, by comparing the triangular waveform with the error signal. When the triangular waveform is set as the comparison of the error signal, both of a time point (on) when the output signal of the controller is output firstly and a time point (off) when the output signal of the controller disappears are changed. For example, dual edges of the duty are changed. Therefore, as illustrated in (c) of FIG. 2B, the first switch unit 111 in the first DCDC converter 110 and the second switch unit 121 in the second DCDC converter 120 are not turned on simultaneously.

In FIG. 2B, (d) illustrates a current change of the inductor according to the on state (duty state) of the switch unit. As illustrated in (d) of FIG. 2B, the current of the inductor increases when the switch is in the on state (duty state), and the current of the inductor decreases when the switch is in the off state. The first switch unit 111 in the first DCDC converter 110 and the second switch unit 112 in the second DCDC converter 120 are prevented from simultaneously being in the on states, and thus a current change is comparatively less.

The dual edge modulation method moves up the time point when the switch is turned on and delays the time point when the switch is turned off, or delays the time point when the switch is turned on and moves up the time point when the switch is turned off, when the time of the on state (duty state) of the switch unit is changed (increased or decreased) so as to remove the error (voltage increase or decrease) of the output voltage. For example, since the duty state is increased or decreased at the dual edges of both sides, the first switch unit 111 and the second switch unit 121 may be prevented from being simultaneous on states in advance.

For example, when the first DCDC converter 110 is used as a buck converter and the second DCDC converter 120 is used as a buck boost converter, in a case of the buck boost converter, the on state (duty state) of the second switch unit may be equal to or greater than about 0.5 according to setting of an input voltage and an output voltage, and thus the first switch unit and the second switch unit may be turned on simultaneously. Therefore, when the dual edge modulation method is used so as to detect the error of the voltage, the first switch unit and the second switch unit may be prevented from being simultaneous on states as well as the error of the voltage (voltage increase) may be detected.

In the electric power device using the dual edge modulation method, when the voltage Vout1 output from the first DCDC converter 110 is different from the voltage of the first DCDC converter 110, the first controller 112 may increase the on state time (duty state) of the first switch unit 111 in order to control the first DCDC converter 110 so that the first DCDC converter 110 outputs the voltage.

In addition, when the voltage Vout2 output from the second DCDC converter 120 is different from the voltage of the second DCDC converter 120, the second controller 122 may increase the on state time (duty state) of the second switch unit 121 in order to control the second DCDC converter 120 so that the second DCDC converter 120 outputs the voltage.

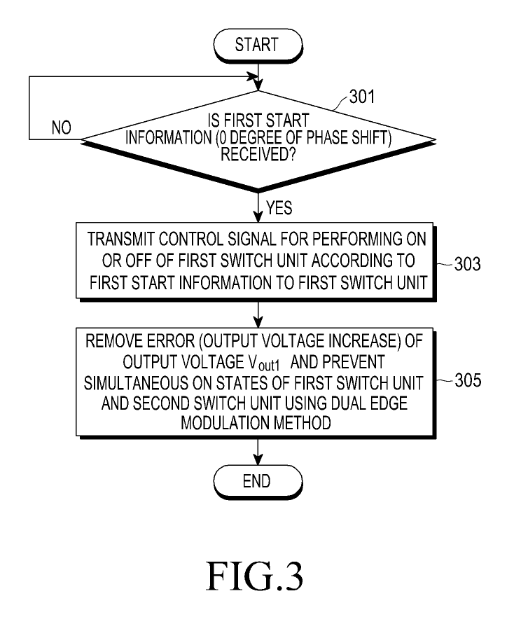

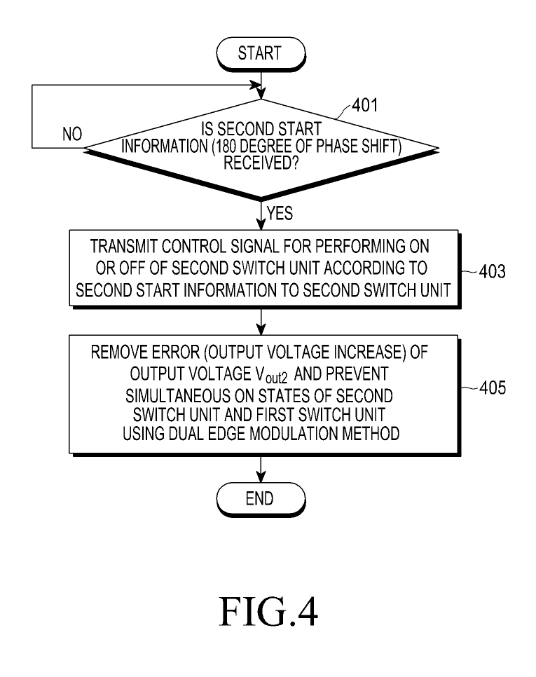

The output operations of the voltages of the respective first DCDC converter and second DCDC converter using the inductor illustrated in FIG. 1 may be described with reference to FIGS. 3 and 4.

FIG. 3 is a flowchart illustrating a voltage output operation of a first DCDC converter in an electric power device according to an embodiment of the present disclosure.

Referring to FIG. 3, with reference to FIG. 1, when the first start information including the 0 degree of phase shift information is received in operation 301, the first controller 112 may periodically transmit the control signal for performing the on or off of the first switch unit 111 to the first switch unit 111 without the phase delay according to the 0 degree of phase shift information in operation 303.

When the first switch unit 111 is turned on according to the control signal transmitted from the first controller 112, the current is stored in the inductor 130, and when the first switch unit 111 is turned off, the input voltage Vin1 and the voltage of the single inductor 130 are added, and thus the voltage of the first DCDC converter 110 may be output.

The first error detecting unit 113 may compare the voltage Vout1 output from the single inductor 130 with the first critical voltage. As the result of the comparison, the voltage output from the single inductor 130 is different from the first critical voltage, the first error detecting unit 113 may transmit the error occurrence information to the first controller 112. The first controller 112 maintains the on state (duty state) of the first switch unit 111 using the dual edge modulation method in operation 305 so the voltage of the first DCDC converter 110 may be output. In addition, when the first controller 112 receives the error occurrence information from the first error detecting unit 113, the first controller 112 may control (increase or decrease) the on state (duty state) of the first switch unit 111 to remove the error in the output voltage Vout1 (increase or decrease of the output voltage).

The first controller 112 controls the on state (duty state) of the first switch unit 111 using the dual edge modulation method in operation 305, and thus the simultaneous on states of the first switch unit 111 and the second switch unit 121 may be prevented while removing the error of the output voltage Vout1 (increase or decrease of the output voltage).

FIG. 4 is a flowchart illustrating a voltage output operation of a second DCDC converter in an electric power device according to an embodiment of the present disclosure.

Referring to FIG. 4, with reference to FIG. 1, when the second start information including the 180 degrees of phase shift information is received in operation 401, the second controller 122 may periodically transmit the control signal for switching the second switch unit 121 to the on or off state unit to the second switch unit 121 after the 180 degrees of phase delay according to the 180 degrees of phase shift information is received in operation 403.

When the second switch unit 121 is turned on according to the control signal transmitted from the second controller 122, the current is stored in the inductor 130, and when the second switch unit 121 is turned off, the input voltage Vin2 and the voltage of the single inductor 130 are added, and thus the voltage of the second DCDC converter 120 may be output.

The second error detecting unit 123 may compare the voltage Vout2 output from the single inductor 130 with the second critical voltage. As the result of the comparison, the voltage Vout2 output from the single inductor 130 is different from the second critical voltage, the second error detecting unit 123 may transmit the error occurrence information to the second controller 122.

The second controller 122 maintains the on state (duty state) of the second switch unit 121 using the dual edge modulation method in operation 405 so the voltage of the second DCDC converter 120 may be output. In addition, when the second controller 122 receives the error occurrence information from the second error detecting unit 123, the second controller 122 may control (increase or decrease) the on state (duty state) of the second switch unit 121 to remove the error of the output voltage Vout2 (increase or decrease of the output voltage).

The second controller 122 controls the on state (duty state) of the second switch unit 121 using the dual edge modulation method in operation 405, and thus the simultaneous on states of the second switch unit 121 and the first switch unit 111 may be prevented while removing the error of the output voltage Vout2 (increase or decrease of the output voltage).

It is possible to realize the electric power device and the method for providing the electric power in the electric power device according to the various embodiments of the present disclosure as a computer-readable code in a computer-readable recording medium. The computer-readable recording medium includes all types of recording devices which store data readable by a computer system. Examples of the recording medium include a Read-Only Memory (ROM), a Random Access Memory (RAM), an optical disk, a magnetic tape, a floppy disk, a hard disk, a nonvolatile memory, and the like, and also include things realized in a form of a carrier wave (for example, transmission through the Internet). Further, the computer-readable recording medium may be dispersed in computer systems connected through a network, and a computer-readable code may be stored and executed in a dispersion scheme.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electric power device comprising:
an inductor; and
a plurality of converters configured to output voltages using the inductor.

2. The electric power device of claim 1, wherein the inductor comprises a coupled inductor.

3. The electric power device of claim 1, wherein each of the converters comprises a DCDC converter connected to a power rail.

4. The electric power device of claim 1, wherein each of the converters comprises:
a switch unit configured to be turned on or turned off according to a control signal of a controller,
wherein the controller is configured to transmit the control signal for controlling an on or an off state of the switch unit after a phase delay according to phase shift information, when the controller receives a start signal comprising the phase shift information, and
wherein the controllers respectively comprised in the converters receive different start signal information comprising phase shift information, and control an output voltage corresponding to the converter by controlling an on time and an off time of the switch unit.

5. The electric power device of claim 4, further comprising:
an error detecting unit configured:
to detect an error in a voltage output from the inductor, and
to transmit error occurrence information to the controller,
wherein the controller controls an on state of the switch unit by controlling the on time and the off time of the switch unit, when the controller receives the error occurrence information from the error detecting unit.

6. The electric power device of claim 4, wherein the controlling of the on time and the off time of the switch unit comprises a dual edge modulation method.

7. An electric power device comprising:
an inductor;
a first converter configured to output a first voltage using the inductor; and
a second converter configured to output a second voltage using the inductor.

8. The electric power device of claim 7, wherein the inductor comprises a coupled inductor.

9. The electric power device of claim 7, wherein each of the first converter and the second converter comprises a DCDC converter connected to a power rail.

10. The electric power device of claim 7, wherein the first converter comprises:
a first switch unit configured to be turned on or turned off according to a control signal of a first controller,
wherein the first controller is configured:
to transmit the control signal for controlling an on or an off state of the first switch unit after a phase delay according to phase shift information, when the first controller receives a first start signal comprising phase shift information, and
to control an output voltage of the first converter by controlling an on time and an off time of the first switch unit, and
wherein the phase shift information of the first start information is different from phase shift information comprised in a second start information sent to a second controller of the second converter.

11. The electric power device of claim 10, further comprising:
a first error detecting unit configured:
to detect an error in a voltage output from the inductor, and
to transmit error occurrence information to the first controller,
wherein the first controller controls an on state of the first switch unit by controlling the on time and the off time of the first switch unit, when the first controller receives the error occurrence information from the first error detecting unit.

12. The electric power device of claim 10, wherein the controlling of the on time and the off time of the first switch unit is a dual edge modulation method.

13. The electric power device of claim 7, wherein the second converter comprises:
a second switch unit configured to be turned on or turned off according to a control signal of a second controller,
wherein the second controller is configured:
to transmit the control signal for controlling an on or an off state of the second switch unit after a phase delay according to phase shift information, when the second controller receives a second start signal comprising phase shift information, and
to control an output voltage of the second converter by controlling an on time and an off time of the second switch unit, and
wherein the phase shift information of the second start information is different from phase shift information comprised in a first start information sent to a first controller of the first converter.

14. The electric power device of claim 13, further comprising:
a second error detecting unit configured:
to detect an error in a voltage output from the inductor, and
to transmit error occurrence information to the second controller,
wherein the second controller controls an on state of the second switch unit by controlling the on time and the off time of the second switch unit, when the second controller receives the error occurrence information from the second error detecting unit.

15. The electric power device of claim 13, wherein the controlling of the on time and the off time of the second switch unit comprises a dual edge modulation method.

16. A method for providing an electric power in an electric power device, the method comprising:
transmitting a control signal for controlling an on or an off state of a switch unit to the switch unit after a phase delay according to phase shift information, when a start information comprising the phase shift information is received; and
controlling an output voltage of the electric power device by controlling an on time and an off time of the switch unit.

17. The method of claim 16, further comprising:
controlling an on state of the switch unit by controlling the on time and the off time of the switch unit, when an error of the output voltage is outputted.

18. The method of claim 16, wherein the controlling of the on time and the off time of the switch unit comprises a dual edge modulation method.

19. The electric power device of claim 6, wherein the dual edge modulation method comprises at least one of moving up the time point when the switch is turned on and delaying the time point when the switch is turned off, and delaying the time point when the switch is turned on and moving up the time point when the switch is turned off, when the time of the on state of the switch unit is changed.

20. The method of claim 18, wherein the dual edge modulation method comprises at least one of moving up the time point when the switch is turned on and delaying the time point when the switch is turned off, and delaying the time point when the switch is turned on and moving up the time point when the switch is turned off, when the time of the on state of the switch unit is changed.
